(19) United States
(12) Patent Application Publication
(10) Pub. No.: US 2025/0324375 A1
(43) Pub. Date: Oct. 16, 2025

(54) METHODS AND APPARATUSES FOR HANDLING DIFFERENT TA IN MULTIPLE TRPS OPERATION

(71) Applicant: LENOVO (BEIJING) LIMITED, Beijing (CN)

(72) Inventors: Lianhai WU, Beijing (CN); Ran YUE, Beijing (CN); Haiming WANG, Beijing (CN); Jing HAN, Beijing (CN); Jie HU, Beijing (CN)

(21) Appl. No.: 18/863,207

(22) PCT Filed: May 6, 2022
(86) PCT No.: PCT/CN2022/091161

§ 371 Date: Nov. 5, 2024

(51) Int. Cl. H04W 56/00; H04W 36/36; H04W 72/231; H04W 74/0833; H04W 76/20

(52) U.S. Cl. CPC H04W 56/0045; H04W 36/362; H04W 72/231; H04W 74/0833; H04W 76/20

(57) ABSTRACT

Embodiments of the present application relate to methods and apparatuses for handling different timing advance (TA) in a multiple transmission reception points (TRPs) operation. According to an embodiment of the present application, a user equipment (UE) includes a transceiver and a processor coupled to the transceiver. The processor may be configured to: access a serving cell with a transmission reception point (TRP) associated with a timing advance (TA); receive a radio resource control (RRC) reconfiguration message related to another TRP associated with another TA via the transceiver from a network, wherein the abovementioned another TA is different from the TA; and perform a random access (RA) procedure to the abovementioned another TRP, after receiving the RRC reconfiguration message.

### TECHNICAL FIELD

Embodiments of the present application generally relate to wireless communication technology, especially to methods and apparatuses for handling different timing advance (TA) in a multiple transmission reception points (TRPs) operation.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Currently, multiple TRPs with one single TA are supported in 3rd Generation Partnership Project (3GPP) standard documents. Multiple TAs for multiple TRPs operation will be supported in 3GPP Rel-18. In some cases, multiple TRPs may also be named as “mTRP” or “multi TRPs” or “multi-TRP” or the like. However, several issues related to handling different TA in a multiple TRPs operation have not been discussed yet and the corresponding solutions have not been specified.

### SUMMARY

Some embodiments of the present application provide a user equipment (UE). The UE includes a transceiver and a processor coupled to the transceiver. The processor may be configured to: access a serving cell with a first transmission reception point (TRP) associated with a first timing advance (TA); receive a radio resource control (RRC) reconfiguration message related to a second TRP associated with a second TA via the transceiver from a network, wherein the second TA is different from the first TA; and perform a first random access (RA) procedure to the second TRP, after receiving the RRC reconfiguration message.

In some embodiments, the first RA procedure is performed upon a reception of the RRC reconfiguration message.

In some embodiments, the RRC reconfiguration message includes an indication for indicating whether the UE performs the first RA procedure upon a reception of the RRC reconfiguration message.

In some embodiments, in response to the indication indicating the UE to perform the first RA procedure upon the reception of the RRC reconfiguration message, the first RA procedure is performed upon the reception of the RRC reconfiguration message; or in response to the indication indicating the UE to not perform the first RA procedure upon the reception of the RRC reconfiguration message, the first RA procedure is performed upon a downlink (DL) data arrival or upon an uplink (UL) data arrival.

In some embodiments, in response to the first RA procedure being failed, the processor of the UE is configured to transmit failure information related to the first RA procedure via the transceiver to the network.

In some embodiments, the processor of the UE is configured to transmit an RRC reconfiguration complete message via the transceiver to the network, after successfully completing the first RA procedure or the first RA procedure being failed.

In some embodiments, the RRC reconfiguration complete message includes at least one of: an indication for indicating whether the first RA procedure is successfully completed; or information related to the first RA procedure.

In some embodiments, the information includes at least one of: one or more preamble sequences for one or more attempts during the first RA procedure; or one or more time-frequency domain resources for the one or more attempts.

In some embodiments, the processor of the UE is configured to: receive a first configuration regarding a first time alignment timer (TAT) for the first TA via the transceiver from the network; and receive a second configuration regarding a second TAT for the second TA via the transceiver from the network.

In some embodiments, in response to both an expiry of the first TAT and an expiry of the second TAT and in response to a downlink (DL) data arrival, the processor of the UE is configured to receive downlink control information (DCI) including a physical downlink control channel (PDCCH) order via the transceiver from the network.

In some embodiments, the PDCCH order includes a dedicated preamble, and wherein the dedicated preamble can be used for both the first TRP and the second TRP or can be used for only one TRP within the first TRP and the second TRP.

In some embodiments, in response to the DCI including at least one of a synchronization signal block (SSB) index or a physical random access channel (PRACH) mask index, the dedicated preamble can be used for the only one TRP.

In some embodiments, the processor of the UE is configured to: determine whether the first TRP or the second TRP is associated with the at least one of the SSB index or the PRACH mask index; and in response to determining that the first TRP is associated with the at least one of the SSB index or the PRACH mask index, perform a second RA procedure to the first TRP using the dedicated preamble; or in response to determining that the second TRP is associated with the at least one of the SSB index or the PRACH mask index, perform a third RA procedure to the second TRP using the dedicated preamble.

In some embodiments, the processor of the UE is configured to: in response to reaching a first maximum number of preamble transmission of the second TRP, determine that the first RA procedure is failed; or in response to reaching a second maximum number of preamble transmission of the first TRP, determine that the second RA procedure is failed; or in response to reaching a third maximum number of preamble transmission of the second TRP, determine that the third RA procedure is failed.

In some embodiments, the processor of the UE is configured to: in response to the second RA procedure being failed, perform a fourth RA procedure to the second TRP; or in response to the third RA procedure being failed, perform a fifth RA procedure to the first TRP.

In some embodiments, the dedicated preamble is not used during the fourth RA procedure or the fifth RA procedure.

In some embodiments, in response to the dedicated preamble can be used for both the first TRP and the second TRP, the processor of the UE is configured to perform a sixth RA procedure to one TRP within the first TRP and the second TRP.

In some embodiments, the PDCCH order does not include a dedicated preamble, and wherein the processor of the UE is configured to: select one TRP within the first TRP and the second TRP; and perform a seventh RA procedure to the one TRP.

In some embodiments, in response to both an expiry of the first TAT and an expiry of the second TAT and in response to an uplink (UL) data arrival, the processor of the UE is configured to: select one TRP within the first TRP and the second TRP; and perform an eighth RA procedure to the one TRP.

In some embodiments, the one TRP is selected based on at least one of a channel quality or a bandwidth.

In some embodiments, in response to reaching a fourth maximum number of preamble transmission of the one TRP, the processor of the UE is configured to perform a ninth RA procedure to another one TRP within the first TRP and the second TRP.

Some embodiments of the present application provide a network node (e.g., a base station (BS)). The network node includes a transceiver and a processor coupled to the transceiver. The processor is configured to: transmit a first radio resource control (RRC) reconfiguration message related to a first transmission reception point (TRP) associated with a first timing advance (TA) via the transceiver to a user equipment (UE); receive a measurement report of the first TRP via the transceiver from the UE; and transmit a second RRC reconfiguration message related to a second TRP associated with a second TA via the transceiver to the UE, wherein the second TA is different from the first TA.

In some embodiments, a first random access (RA) procedure is performed by the UE after receiving the second RRC reconfiguration message.

In some embodiments, the second RRC reconfiguration message includes an indication for indicating whether the UE performs the first RA procedure upon a reception of the second RRC reconfiguration message.

In some embodiments, in response to the indication indicating the UE to perform the first RA procedure upon the reception of the RRC reconfiguration message, the first RA procedure is performed upon the reception of the RRC reconfiguration message; or in response to the indication indicating the UE to not perform the first RA procedure upon the reception of the RRC reconfiguration message, the first RA procedure is performed upon a downlink (DL) data arrival or upon an uplink (UL) data arrival.

In some embodiments, in response to the first RA procedure being failed, the processor of the network node is configured to receive failure information related to the first RA procedure via the transceiver from the UE.

In some embodiments, in response to successfully completing the first RA procedure or the first RA procedure being failed, the processor of the network node is configured to receive an RRC reconfiguration complete message via the transceiver from the UE.

In some embodiments, the RRC reconfiguration complete message includes at least one of: an indication for indicating whether the first RA procedure is successfully completed; or information related to the first RA procedure.

In some embodiments, the information includes at least one of: one or more preamble sequences for one or more attempts during the first RA procedure; or one or more time-frequency domain resources for the one or more attempts.

In some embodiments, the processor of the network node is configured to: receive a first configuration regarding a first time alignment timer (TAT) for the first TA via the transceiver from the UE; and receive a second configuration regarding a second TAT for the second TA via the transceiver from the UE.

In some embodiments, in response to both an expiry of the first TAT and an expiry of the second TAT and in response to a downlink (DL) data arrival, the processor of the network node is configured to transmit downlink control information (DCI) including a physical downlink control channel (PDCCH) order via the transceiver to the UE.

In some embodiments, the PDCCH order includes a dedicated preamble, and wherein the dedicated preamble can be used for both the first TRP and the second TRP or can be used for only one TRP within the first TRP and the second TRP.

In some embodiments, in response to the DCI including at least one of a synchronization signal block (SSB) index or a physical random access channel (PRACH) mask index, the dedicated preamble can be used for the only one TRP.

Some embodiments of the present application provide a UE. The UE includes a transceiver and a processor coupled to the transceiver. The processor may be configured to: receive a radio resource control (RRC) reconfiguration message associated with a target cell via the transceiver from a network, wherein the RRC reconfiguration message includes a configuration related to one or more transmission reception points (TRPs) of the target cell, and wherein two or more TRPs within the one or more TRPs respectively have different timing advance (TA) in response to the configuration being related to the two or more TRPs; and perform a first random access (RA) procedure and start a mobility timer.

In some embodiments, the target cell is a primary cell of a master cell group (PCell) or a primary cell of a second cell group (PSCell).

In some embodiments, in response to allowing only one TRP to be configured to the target cell, the configuration is related to the one TRP, and the first RA procedure is to the one TRP.

In some embodiments, the first RA procedure is associated with at least one of: a PCell change procedure; a PSCell addition procedure; a PSCell change procedure; a conditional PCell handover (CHO) procedure; a conditional PSCell addition (CPA) procedure; or a conditional PSCell change (CPC) procedure.

In some embodiments, in response to the configuration being related to the two or more TRPs, the RRC reconfiguration message includes information regarding each TRP within the two or more TRPs.

In some embodiments, the information regarding the each TRP includes at least one of: identity (ID) information of the each TRP; a first indication for indicating whether the UE performs the first RA procedure to the first TRP upon a reception of the RRC reconfiguration message; a second indication for indicating the UE not to perform a second RA procedure to a second TRP within the two or more TRPs when the mobility timer is running; a third indication for indicating the UE to perform the second RA procedure to the second TRP after an expiry of the mobility timer; a fourth indication for indicating the UE to perform the second RA procedure to the second TRP after the expiry of the mobility timer and upon a downlink (DL) data arrival; or a fifth indication for indicating the UE to perform the second RA procedure to the second TRP after the expiry of the mobility timer and upon an uplink (UL) data arrival.

In some embodiments, in response to the first indication indicating the UE to perform the first RA procedure upon the reception of the RRC reconfiguration message, the first RA procedure is performed upon the reception of receiving the RRC reconfiguration message; or in response to the first indication indicating the UE to not perform the first RA procedure upon the reception of the RRC reconfiguration message, the first RA procedure is performed upon the DL data arrival or the UL data arrival.

In some embodiments, in response to the first RA procedure being failed, the processor of the UE is configured to transmit failure information related to the first RA procedure via the transceiver to the network.

In some embodiments, in response to successfully completing the first RA procedure, the processor of the UE is configured to: stop the mobility timer upon a successful completion of the first RA procedure; and transmit an RRC reconfiguration complete message via the transceiver to the network.

Some embodiments of the present application provide a network node (e.g., a BS). The network node includes a transceiver and a processor coupled to the transceiver. The processor is configured to transmit a radio resource control (RRC) reconfiguration message associated with a target cell via the transceiver to a user equipment (UE), wherein the RRC reconfiguration message includes a configuration related to one or more transmission reception points (TRPs) of the target cell, and wherein two or more TRPs within the one or more TRPs respectively have different timing advance (TA) in response to the configuration being related to the two or more TRPs.

In some embodiments, the target cell is a primary cell of a master cell group (PCell) or a primary cell of a second cell group (PSCell).

In some embodiments, in response to allowing only one TRP to be configured to the target cell, the configuration is related to the one TRP, and a first random access (RA) procedure is performed by the UE to the one TRP.

In some embodiments, the first RA procedure is associated with at least one of: a PCell change procedure; a PSCell addition procedure; a PSCell change procedure; a conditional PCell handover (CHO) procedure; a conditional PSCell addition (CPA) procedure; or a conditional PSCell change (CPC) procedure.

In some embodiments, in response to the configuration being related to the two or more TRPs, the RRC reconfiguration message includes information regarding each TRP within the two or more TRPs.

In some embodiments, the information regarding the each TRP includes at least one of: identity (ID) information of the each TRP; a first indication for indicating whether the UE performs the first RA procedure to the first TRP upon a reception of the RRC reconfiguration message; a second indication for indicating the UE not to perform a second RA procedure to a second TRP within the two or more TRPs when the mobility timer is running; a third indication for indicating the UE to perform the second RA procedure to the second TRP after an expiry of the mobility timer; a fourth indication for indicating the UE to perform the second RA procedure to the second TRP after the expiry of the mobility timer and upon a downlink (DL) data arrival; or a fifth indication for indicating the UE to perform the second RA procedure to the second TRP after the expiry of the mobility timer and upon an uplink (UL) data arrival.

In some embodiments, in response to the first indication indicating the UE to perform the first RA procedure upon the reception of the RRC reconfiguration message, the first RA procedure is performed upon the reception of the RRC reconfiguration message; or in response to the first indication indicating the UE to not perform the first RA procedure upon the reception of the RRC reconfiguration message, the first RA procedure is performed upon the DL data arrival or the UL data arrival.

In some embodiments, in response to the first RA procedure being failed, the processor of the network node is configured to receive failure information related to the first RA procedure via the transceiver from the UE.

In some embodiments, in response to successfully completing the first RA procedure, the processor of the network node is configured to receive an RRC reconfiguration complete message via the transceiver from the UE.

Some embodiments of the present application provide a method performed by a UE). The method includes: accessing a serving cell with a first transmission reception point (TRP) associated with a first timing advance (TA); receiving a radio resource control (RRC) reconfiguration message related to a second TRP associated with a second TA from a network, wherein the second TA is different from the first TA; and performing a first random access (RA) procedure to the second TRP, after receiving the RRC reconfiguration message.

Some embodiments of the present application provide a method performed by network node (e.g., a BS). The method includes: transmitting a first radio resource control (RRC) reconfiguration message related to a first transmission reception point (TRP) associated with a first timing advance (TA) to a user equipment (UE); receiving a measurement report of the first TRP from the UE; and transmitting a second RRC reconfiguration message related to a second TRP associated with a second TA to the UE, wherein the second TA is different from the first TA.

Some embodiments of the present application provide a method performed by a UE). The method includes: receiving a radio resource control (RRC) reconfiguration message associated with a target cell from a network, wherein the RRC reconfiguration message includes a configuration related to one or more transmission reception points (TRPs) of the target cell, and wherein two or more TRPs within the one or more TRPs respectively have different timing advance (TA) in response to the configuration being related to the two or more TRPs; and performing a first random access (RA) procedure and start a mobility timer.

Some embodiments of the present application provide a method performed by network node (e.g., a BS). The method includes: transmitting a radio resource control (RRC) reconfiguration message associated with a target cell to a user equipment (UE), wherein the RRC reconfiguration message includes a configuration related to one or more transmission reception points (TRPs) of the target cell, and wherein two or more TRPs within the one or more TRPs respectively have different timing advance (TA) in response to the configuration being related to the two or more TRPs.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary communication system of multiple TRPs according to some embodiments of the present application.

FIGS. 2-4 illustrate exemplary flowcharts of handling different TA in a multiple TRPs according to some embodiments of the present application.

FIGS. 5-8 illustrate flowcharts of exemplary procedures of wireless communications according to some embodiments of the present application.

FIG. 9 illustrates a block diagram of an exemplary apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

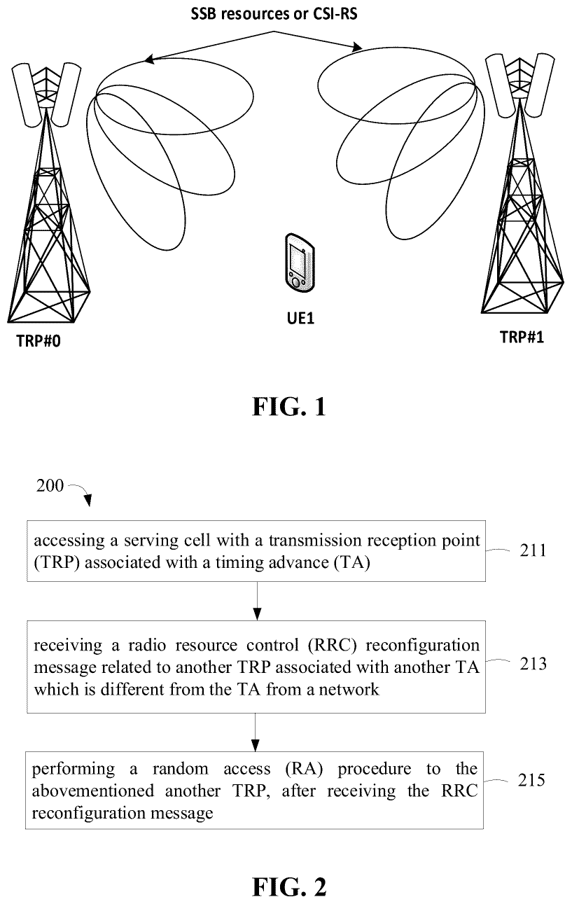

FIG. 1 illustrates an exemplary communication system of multiple TRPs according to some embodiments of the present application.

In some cases, UE1 may receive, from a serving cell, configuration(s) of SSB(s) or a CSI-RS of a TRP (e.g., TRP #0 and/or TRP #1) with a PCID for a beam measurement and resource configuration(s) for data transmission or data reception associated with the PCID. UE1 performs a beam measurement for the TRP with the PCID and reports a measurement result to the serving cell. Based on the above reports, TCI state(s) associated with the TRP with the PCID is activated from the serving cell (by L1 signaling or L2 signaling). A TCI may be a SSB or a CSI-RS. UE1 receives and transmits using a UE-dedicated channel on the TRP with the PCID. UE1 should be in coverage of a serving cell always, also for a multi-TRP case, e.g., UE1 should use BCCH, PCCH, etc., from the serving cell. As shown in FIG. 1, UE1 is served by TRP #0 and TRP #1. UE1 can receive data from TRP #0 and TRP #1 at the same time.

In some embodiments of the present application, UE1 as shown in FIG. 1 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, networks (e.g., TRPs, routers, switches, and modems), or the like. In some other embodiments of the present application, UE1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE1 may include wearable devices, such as smart watches, fitness bands, optical head-mounted displays, or the like. Moreover, UE1 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application, UE1 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE1 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE1 may include wearable devices, such as smart watches, fitness bands, optical head-mounted displays, or the like. Moreover, UE1 may be referred to as a subscriber unit, a mobile, a mobile station, a user, a terminal, a mobile terminal, a wireless terminal, a fixed terminal, a subscriber station, a user terminal, or a device, or described using other terminology used in the art.

Currently, a scenario regarding multiple TRPs with different TA configured to a target PCell or a target PSCell has not been discussed yet and several issues need to be addressed. Embodiments of the subject application aim to solve issues that may be faced in such scenario. Some embodiments of the subject application design a mechanism for a case that one or more TRPs are configured by a target BS in a handover case. Some embodiments of the subject application specify a mechanism for a case that a BS may configure another TRP associated with a different TA to a UE after the UE has a connection with one TRP associated with a TA (e.g., the one TRP associated with the TA is already available). Some embodiments of the subject application design a mechanism for a case that different TAT per TRP timers will be configured for multiple TRPs and all TAT timers expire when downlink (DL) or uplink (UL) data arrives.

More details regarding embodiments of the present application will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

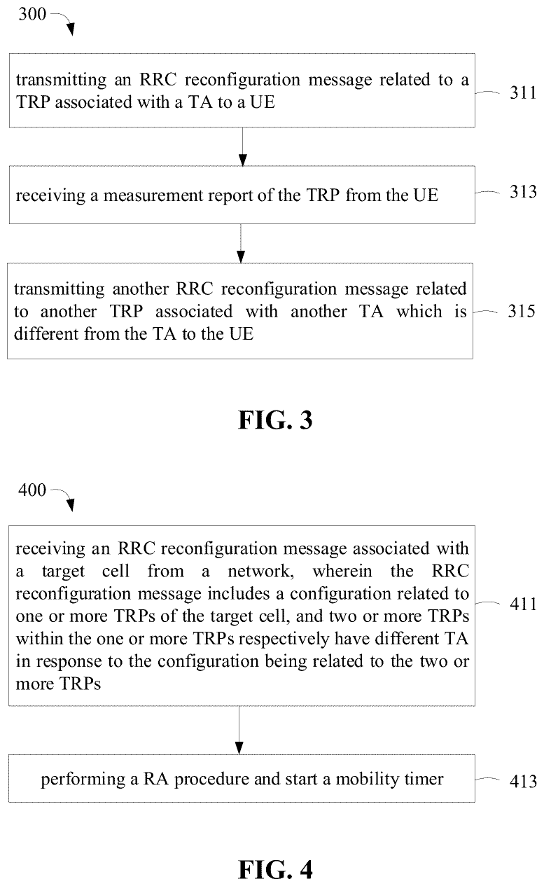

FIG. 2 illustrates an exemplary flowchart of handling different TA in a multiple TRPs operation according to some embodiments of the present application. The exemplary method 200 in FIG. 2 may be performed by a UE (e.g., UE1 as shown in FIG. 1). Although described with respect to a UE, it should be understood that other devices may also be configured to perform the method as shown in FIG. 2.

In the exemplary method 200 as shown in FIG. 2, in operation 211, a UE (e.g., UE1 as shown in FIG. 1) accesses a serving cell with a TRP (denoted as “1st TRP” for simplicity) associated with a TA (denoted as “1st TA” for simplicity).

In operation 213, the UE receives an RRC reconfiguration message related to another TRP (denoted as “2nd TRP” for simplicity) associated with another TA (denoted as “2nd TA” for simplicity) from a network (e.g., a BS). The 2nd TA is different from the 1st TA.

In operation 215, the UE performs an RA procedure (denoted as “1st RA procedure” for simplicity) to the 2nd TRP, after receiving the RRC reconfiguration message. In some embodiments, the 1st RA procedure is performed upon a reception of the RRC reconfiguration message.

In some embodiments, the RRC reconfiguration message includes an indication for indicating whether the UE performs the 1st RA procedure upon a reception of the RRC reconfiguration message. In an embodiment, in response to the indication indicating the UE to perform the 1st RA procedure upon the reception of the RRC reconfiguration message, the 1st RA procedure is performed upon the reception of the RRC reconfiguration message. In a further embodiment, in response to the indication indicating the UE to not perform the 1st RA procedure upon the reception of the RRC reconfiguration message, the 1st RA procedure is performed upon a DL data arrival or upon a UL data arrival.

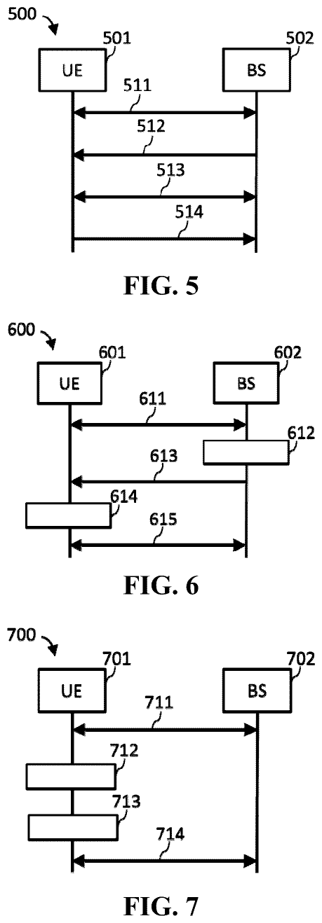

In some embodiments, in response to the 1st RA procedure being failed, the UE transmits failure information related to the 1st RA procedure to the network. A specific example is described in embodiments of FIG. 5 as follows.

In some embodiments, the UE transmits an RRC reconfiguration complete message to the network, after successfully completing the 1st RA procedure or the 1st RA procedure being failed. In an embodiment, the RRC reconfiguration complete message includes at least one of:
(1) an indication for indicating whether the 1st RA procedure is successfully completed; or
   (2) information related to the 1st RA procedure. For instance, the information includes at least one of: one or more preamble sequences for one or more attempts during the 1st RA procedure; or one or more time-frequency domain resources (e.g., random access channel (RACH) occasion(s)) for the one or more attempts. A specific example is described in embodiments of FIG. 5 as follows.

In some embodiments, the UE receives a configuration regarding a time alignment timer (TAT) (denoted as “1st TAT” for simplicity) for the 1st TA from the network, and receives another configuration regarding another TAT (denoted as “2nd TAT” for simplicity) for the 2nd TA from the network. A specific example is described in embodiments of FIG. 6 as follows.

In an embodiment, in response to both an expiry of the 1st TAT and an expiry of the 2nd TAT and in response to a DL data arrival, the UE receives downlink control information (DCI) including a physical downlink control channel (PDCCH) order from the network. For instance, the PDCCH order includes a dedicated preamble. The dedicated preamble can be used for both the 1st TRP and the 2nd TRP, or can be used for only one TRP within the 1st TRP and the 2nd TRP. For example, in response to the DCI including at least one of a synchronization signal block (SSB) index or a physical random access channel (PRACH) mask index, the dedicated preamble can be used for the only one TRP.

In some embodiments, the UE may determine whether the 1st TRP or the 2nd TRP is associated with at least one of the SSB index or the PRACH mask index. In response to determining that the 1st TRP is associated with the at least one of the SSB index or the PRACH mask index, the UE may perform another RA procedure (denoted as “2nd RA procedure” for simplicity) to the 1st TRP using the dedicated preamble. In response to determining that the 2nd TRP is associated with at least one of the SSB index or the PRACH mask index, the UE may perform another RA procedure (denoted as “3rd RA procedure” for simplicity) to the 2nd TRP using the dedicated preamble.

In some embodiments, in response to reaching a maximum number of preamble transmission of the 2nd TRP, the UE may determine that the 1st RA procedure is failed. In response to reaching a maximum number of preamble transmission of the 1st TRP, the UE may determine that the 2nd RA procedure is failed. In response to reaching a maximum number of preamble transmission of the 2nd TRP, the UE may determine that the 3rd RA procedure is failed.

In some embodiments, in response to the 2nd RA procedure being failed, the UE may perform an RA procedure (denoted as “4th RA procedure” for simplicity) to the 2nd TRP. In response to the 3rd RA procedure being failed, the UE may perform an RA procedure (denoted as “5th RA procedure” for simplicity) to the 1st TRP. In an embodiment, the dedicated preamble is not used during the 4th RA procedure or the 5th RA procedure. A specific example is described in embodiments of FIG. 6 as follows.

In some embodiments, in response to the dedicated preamble can be used for both the 1st TRP and the 2nd TRP, the UE may perform an additional RA procedure to one TRP within the 1st TRP and the 2nd TRP. In an embodiment, in response to reaching a maximum number of preamble transmission of the one TRP, the UE may perform an RA procedure to another one TRP within the 1st TRP and the 2nd TRP.

In some embodiments, the PDCCH order does not include a dedicated preamble, and the UE may select one TRP within the 1st TRP and the 2nd TRP and perform yet another RA procedure to the one TRP. For instance, the one TRP is selected based on at least one of a channel quality or a bandwidth. In an embodiment, in response to reaching a maximum number of preamble transmission of the one TRP, the UE may perform an RA procedure to another one TRP within the 1st TRP and the 2nd TRP. A specific example is described in embodiments of FIG. 6 as follows.

In some embodiments, in response to both an expiry of the 1st TAT and an expiry of the 2nd TAT and in response to a UL data arrival, the UE may select one TRP within the 1st TRP and the 2nd TRP and perform yet another RA procedure to the one TRP. For instance, the one TRP is selected based on at least one of a channel quality or a bandwidth. In an embodiment, in response to reaching a maximum number of preamble transmission of the one TRP, the UE may perform an RA procedure to another one TRP within the 1st TRP and the 2nd TRP. A specific example is described in embodiments of FIG. 7 as follows.

FIG. 3 illustrates an exemplary flowchart of handling different TA in a multiple TRPs according to some embodiments of the present application. The exemplary method 300 in FIG. 3 may be performed by a BS. Although described with respect to a BS, it should be understood that other devices may also be configured to perform the method as shown in FIG. 3.

In the exemplary method 300 as shown in FIG. 3, in operation 311, a BS transmits an RRC reconfiguration message related to a TRP (denoted as “1st TRP” for simplicity) associated with a TA (denoted as “1st TA” for simplicity) to a UE. In operation 313, the BS receives a measurement report of the TRP from the UE. In operation 315, the BS transmits another RRC reconfiguration message (denoted as “2nd RRC reconfiguration message” for simplicity), which is related to another TRP (denoted as “2nd TRP” for simplicity) associated with another TA (denoted as “2nd TA” for simplicity), to the UE. The 2nd TA is different from the 1st TA.

In some embodiments, an RA procedure (denoted as “1st RA procedure” for simplicity) is performed by the UE after receiving the 2nd RRC reconfiguration message.

In some embodiments, the 2nd RRC reconfiguration message includes an indication for indicating whether the UE performs the 1st RA procedure upon a reception of the second RRC reconfiguration message. In an embodiment, in response to the indication indicating the UE to perform the 1st RA procedure upon the reception of the RRC reconfiguration message, the 1st RA procedure is performed upon the reception of the RRC reconfiguration message. In a further embodiment, in response to the indication indicating the UE to not perform the 1st RA procedure upon the reception of the RRC reconfiguration message, the 1st RA procedure is performed upon a DL data arrival or upon a UL data arrival. A specific example is described in embodiments of FIG. 5 as follows.

In some embodiments, in response to the 1st RA procedure being failed, the network node may receive failure information related to the 1st RA procedure from the UE.

In some embodiments, in response to successfully completing the 1st RA procedure or the 1st RA procedure being failed, the network node may receive an RRC reconfiguration complete message from the UE. In an embodiment, the RRC reconfiguration complete message includes at least one of:
(1) an indication for indicating whether the 1st RA procedure is successfully completed; or
(2) information related to the 1st RA procedure. For example, the information includes at least one of: one or more preamble sequences for one or more attempts during the 1st RA procedure; or one or more time-frequency domain resources (RACH occasion(s)) for the one or more attempts. A specific example is described in embodiments of FIG. 5 as follows.

In some embodiments, the network node may receive a configuration regarding a TAT (denoted as “1st TAT” for simplicity) for the 1st TA from the UE, and receive a configuration regarding another TAT (denoted as “2nd TAT” for simplicity) for the 2nd TA from the UE. In an embodiment, in response to both an expiry of the 1st TAT and an expiry of the 2nd TAT and in response to a DL data arrival, the network node may transmit DCI including a PDCCH order to the UE. The PDCCH order may include a dedicated preamble. The dedicated preamble can be used for both the first TRP and the second TRP, or can be used for only one TRP within the first TRP and the second TRP. For example, in response to the DCI including at least one of a SSB index or a PRACH mask index, the dedicated preamble can be used for the only one TRP. A specific example is described in embodiments of FIG. 6 as follows.

FIG. 4 illustrates an exemplary flowchart of handling different TA in a multiple TRPs according to some embodiments of the present application. The exemplary method 400 in FIG. 4 may be performed by a UE (e.g., UE1 as shown in FIG. 1). Although described with respect to a UE, it should be understood that other devices may also be configured to perform the method as shown in FIG. 4.

In the exemplary method 400 as shown in FIG. 4, in operation 411, a UE (e.g., UE1 as shown in FIG. 1) receives an RRC reconfiguration message associated with a target cell via the transceiver from a network. The RRC reconfiguration message may include a configuration related to one or more TRPs of the target cell. Two or more TRPs within the one or more TRPs respectively have different TA in response to the configuration being related to the two or more TRPs. In operation 413, the UE performs an RA procedure (denoted as “1st RA procedure” for simplicity) and start a mobility timer (e.g., T304). A specific example is described in embodiments of FIG. 8 as follows.

In some embodiments, the target cell is a primary cell of a master cell group (PCell) or a primary cell of a second cell group (PSCell).

In some embodiments, in response to allowing only one TRP to be configured to the target cell, the configuration is related to the one TRP, and the 1st RA procedure is to the one TRP. In an embodiment, the 1st RA procedure is associated with at least one of:
(1) a PCell change procedure;
(2) a PSCell addition procedure;
(3) a PSCell change procedure;
(4) a conditional PCell handover (CHO) procedure;
(5) a conditional PSCell addition (CPA) procedure; or
(6) a conditional PSCell change (CPC) procedure.

In some embodiments, in response to the configuration being related to the two or more TRPs, the RRC reconfiguration message includes information regarding each TRP within the two or more TRPs. For instance, the information regarding the each TRP may include at least one of:
(1) Identity (ID) information of the each TRP.
(2) An indication for indicating whether the UE performs the 1st RA procedure to the 1st TRP upon a reception of the RRC reconfiguration message. In an embodiment, in response to the indication indicating the UE to perform the 1st RA procedure upon the reception of the RRC reconfiguration message, the 1st RA procedure is performed upon the reception of receiving the RRC reconfiguration message. In a further embodiment, in response to the indication indicating the UE to not perform the 1st RA procedure upon the reception of the RRC reconfiguration message, the 1st RA procedure is performed upon the DL data arrival or the UL data arrival.
(3) An indication for indicating the UE not to perform another RA procedure (denoted as “2nd RA procedure” for simplicity) to another TRP (denoted as “2nd TRP” for simplicity) within the two or more TRPs when the mobility timer is running.
(4) An indication for indicating the UE to perform the 2nd RA procedure to the 2nd TRP after an expiry of the mobility timer.
(5) An indication for indicating the UE to perform the 2nd RA procedure to the 2nd TRP after the expiry of the mobility timer and upon a DL data arrival.
(6) An indication for indicating the UE to perform the 2nd RA procedure to the 2nd TRP after the expiry of the mobility timer and upon a UL data arrival.

In some embodiments, in response to the 1st RA procedure being failed, the UE may transmit failure information related to the 1st RA procedure to the network.

In some embodiments, in response to successfully completing the 1st RA procedure, the UE may stop the mobility timer upon a successful completion of the 1st RA procedure, and transmit an RRC reconfiguration complete message to the network.

It should be appreciated by persons skilled in the art that the sequence of the operations in exemplary procedures 200, 300, and 400 may be changed and some of the operations in exemplary procedures 200, 300, and 400 may be eliminated or modified, without departing from the spirit and scope of the disclosure. Details described in all other embodiments of the present application are applicable for the embodiments of FIGS. 2-4. Moreover, details described in the embodiments of FIGS. 2-4 are applicable for all the embodiments of FIGS. 1 and 5-9.

In addition, some embodiments of the present application provide an exemplary flowchart of a network node (e.g., a BS) transmitting an RRC reconfiguration message for mobility according to some embodiments of the present application. Although described with respect to a network node, it should be understood that other devices may be configured to perform a similar method.

It should be appreciated by persons skilled in the art that the sequence of the operations in this exemplary flowchart of a network node may be changed and some of the operations in this exemplary flowchart may be eliminated or modified, without departing from the spirit and scope of the disclosure. Details described in all other embodiments of the present application, e.g., in the embodiments of FIGS. 2-4 are applicable for this exemplary flowchart. Moreover, details described in this exemplary flowchart are applicable for all the embodiments of FIGS. 1-9.

In particular, in this exemplary flowchart, a BS transmits an RRC reconfiguration message associated with a target cell to a UE. The RRC reconfiguration message may include a configuration related to one or more TRPs of the target cell. In response to the configuration being related to the two or more TRPs, two or more TRPs within the one or more TRPs may respectively have different TA. In some embodiments, the target cell is a PCell or a PSCell. A specific example is described in embodiments of FIG. 8 as follows.

In some embodiments, in response to allowing only one TRP to be configured to the target cell, the configuration is related to the one TRP, and an RA procedure (denoted as “1st RA procedure” for simplicity) is performed by the UE to the one TRP. In an embodiment, the 1st RA procedure is associated with at least one of:
(1) a PCell change procedure;
(2) a PSCell addition procedure;
(3) a PSCell change procedure;
(4) a conditional PCell handover (CHO) procedure;
(5) a conditional PSCell addition (CPA) procedure; or
(6) a conditional PSCell change (CPC) procedure.

In some embodiments, in response to the configuration being related to the two or more TRPs, the RRC reconfiguration message includes information regarding each TRP within the two or more TRPs. For instance, the information regarding the each TRP includes at least one of:
(1) ID information of the each TRP.
(2) An indication for indicating whether the UE performs the first RA procedure to the first TRP upon a reception of the RRC reconfiguration message. In an embodiment, in response to the indication indicating the UE to perform the 1st RA procedure upon the reception of the RRC reconfiguration message, the 1st RA procedure is performed upon the reception of the RRC reconfiguration message. In a further embodiment, in response to the indication indicating the UE to not perform the 1st RA procedure upon the reception of the RRC reconfiguration message, the 1st RA procedure is performed upon the DL data arrival or the UL data arrival.
(3) An indication for indicating the UE not to perform a second RA procedure to a second TRP within the two or more TRPs when the mobility timer is running.
(4) An indication for indicating the UE to perform the second RA procedure to the second TRP after an expiry of the mobility timer.
(5) An indication for indicating the UE to perform the second RA procedure to the second TRP after the expiry of the mobility timer and upon a downlink (DL) data arrival.
(6) An indication for indicating the UE to perform the second RA procedure to the second TRP after the expiry of the mobility timer and upon an uplink (UL) data arrival.

In some embodiments, in response to the 1st RA procedure being failed, the network node may receive failure information related to the 1st RA procedure from the UE.

In some embodiments, in response to successfully completing the 1st RA procedure, the network node may receive an RRC reconfiguration complete message from the UE.

FIG. 5 illustrates a flowchart of an exemplary procedure of wireless communications according to some embodiments of the present application. Details described in all other embodiments of the present disclosure are applicable for the embodiments shown in FIG. 5. Referring to FIG. 5, UE 501 may function as UE1 as shown in FIG. 1.

In particular, in some specific embodiments of FIG. 5, exemplary procedure 500 includes following steps.

In operation 511, UE 501 accesses a serving cell of BS 502. For instance, a TRP (e.g., TRP #0) configured by the serving cell is associated with a TA.

In operation 512, UE 501 receives an RRC reconfiguration message including another TRP (e.g., TRP #1) associated with another TA from BS 502. The abovementioned another TA is different from the TA associated with TRP #0.

In operation 513, UE 501 performs an RA procedure to the abovementioned another TRP (e.g., TRP #1) to keep UL synchronization, after UE 501 receives the RRC reconfiguration message.

After operation 513, there may be different embodiments in different scenarios.
(1) In some embodiments, UE 501 successfully performs the RA procedure to the abovementioned another TRP (e.g., TRP #1), to keep UL synchronization. In operation 514, UE 501 may transmit an RRC reconfiguration complete message to BS 502, after successfully completing the RA procedure.
(2) In some further embodiments, if UE 501 fails to perform the RA procedure to the abovementioned another TRP (e.g., TRP #1), e.g., when a total number of preamble transmission(s) reaches the configured maximum number of RA preamble transmission (e.g., preamble TransMax), UE 501 reports failure information to BS 502 in operation 514.
   a) In an embodiment, UE 501 may further transmit an RRC reconfiguration complete message to BS 502, if UE 501 fails to perform the RA procedure to the abovementioned another TRP (e.g., TRP #1). For instance, after UE 501 receives the RRC reconfiguration message including the abovementioned another TRP (e.g., TRP #1), UE 501 may not transmit an RRC reconfiguration complete message immediately.
   b) In a case that UE 501 transmits the RRC reconfiguration complete message, in an example, whether the RA procedure to TRP #1 is successful or not will be included in the RRC reconfiguration complete message. In a further example, RACH related information per TRP will be included in the RRC reconfiguration complete message. The RACH related information per TRP may include: information regarding a preamble (e.g., a preamble sequence) for each attempt of the RA procedure to TRP #1, and/or information regarding a time-frequency domain resource (e.g., RACH occasion(s)) for each attempt of the RA procedure to TRP #1.

In some further specific embodiments of FIG. 5, exemplary procedure 500 includes following steps.

In operation 511, UE 501 accesses a serving cell of BS 502. For instance, a TRP (e.g., TRP #0) configured by the serving cell is associated with a TA.

In operation 512, UE 501 receives an RRC reconfiguration message including another TRP (e.g., TRP #1) associated with another TA from BS 502. The abovementioned another TA is different from the TA associated with TRP #0. In operation 513, UE 501 performs the RA procedure to the abovementioned another TRP (e.g., TRP #1) to keep UL synchronization based on the indication(s) from BS 502.
(1) In an embodiment, in the RRC reconfiguration message, BS 502 explicitly indicates whether UE 501 needs to perform an RA procedure to the abovementioned another TRP (e.g., TRP #1) when UE 501 receives the RRC reconfiguration message including the abovementioned another TRP (e.g., TRP #1) with the different TA. In an example, BS 502 may indicate UE 501 to perform the RA procedure to the abovementioned another TRP (e.g., TRP #1) upon a reception of the RRC reconfiguration message. In a further example, BS 502 may indicate UE 501 not to perform the RA procedure to the abovementioned another TRP (e.g., TRP #1) upon the reception of the RRC reconfiguration message. In this further example, UE 501 may perform the RA procedure to the abovementioned another TRP (e.g., TRP #1) upon a DL or UL data arrival.
(2) In a further embodiment, in the RRC reconfiguration message, BS 502 may indicate UE 501 to perform the RA procedure to the abovementioned another TRP (e.g., TRP #1) upon a DL or UL data arrival. For example, if BS 502 indicates UE 501 to perform the RA procedure to TRP #1 upon the DL or UL data arrival, UE 501 can perform the RA procedure to TRP #1 when DL or UL data arrives.

After operation 513, there may be different embodiments in different scenarios.
(1) In some embodiments, UE 501 successfully performs the RA procedure to the abovementioned another TRP (e.g., TRP #1), to keep UL synchronization. In operation 514, UE 501 may transmit an RRC reconfiguration complete message to BS 502, after successfully completing the RA procedure.
(2) In some further embodiments, if UE 501 fails to perform the RA procedure to the abovementioned another TRP (e.g., TRP #1), e.g., when a total number of preamble transmission(s) reaches the configured maximum number of RA preamble transmission (e.g., preamble TransMax), UE 501 reports failure information to BS 502 in operation 514.
   a) In an embodiment, UE 501 may further transmit an RRC reconfiguration complete message to BS 502, if UE 501 fails to perform the RA procedure to the abovementioned another TRP (e.g., TRP #1). For instance, after UE 501 receives the RRC reconfiguration message including the abovementioned another TRP (e.g., TRP #1), UE 501 may not transmit an RRC reconfiguration complete message immediately.
   b) In a case that UE 501 transmits the RRC reconfiguration complete message, in an example, whether the RA procedure to TRP #1 is successful or not will be included in the RRC reconfiguration complete message. In a further example, RACH related information per TRP will be included in the RRC reconfiguration complete message. The RACH related information per TRP may include: information regarding a preamble (e.g., a preamble sequence) for each attempt of the RA procedure to TRP #1, and/or information regarding a time-frequency domain resource (e.g., RACH occasion(s)) for each attempt of the RA procedure to TRP #1.

FIG. 6 illustrates a flowchart of an exemplary procedure of wireless communications according to some embodiments of the present application. Details described in all other embodiments of the present disclosure are applicable for the embodiments shown in FIG. 6. Referring to FIG. 6, UE 601 may function as UE1 as shown in FIG. 1. In particular, exemplary procedure 600 includes following steps.

In operation 611, UE 601 accesses a serving cell of BS 602. In an embodiment, two or more TRPs configured by the serving cell are associated with different TA. A TAT timer may be configured for each TRP among the configured TRPs. For instance, a TRP (e.g., TRP #0) is associated with a TA. Another TRP (e.g., TRP #1) is associated with another TA which is different from the TA associated with TRP #0. Two different TAT timers are configured for TRP #0 and TRP #1, respectively.

In operation 612, all TAT timers (e.g., both TAT timers configured for TRP #0 and TRP #1) expire when DL data arrives.

In operation 613, BS 602 transmits DCI, which includes a PDCCH order including a dedicated preamble, to UE 601. In an embodiment, the dedicated preamble indicated in the DCI can be used in all TRPs (e.g., both TRP #0 and TRP #1). In a further embodiment, the dedicated preamble can be used in only one TRP among the configured TRPs if a SSB index and/or a PRACH mask index is included in the DCI.

In operation 614, UE 601 may determine a TRP after receiving the DCI including the PDCCH order. In operation 615, UE 601 may perform an RA procedure to the determined TRP.

In particular, in operation 614, UE 601 can determine the TRP based on the DCI in different manners in different embodiments.
(1) In an embodiment, if the SSB index and/or the PRACH mask index is indicated in the DCI, the dedicated preamble can be used in only one TRP among the configured TRPs. UE 601 can determine the only one TRP based on the SSB index and/or the PRACH mask index included in the DCI. Then, UE 601 may perform an RA procedure to the only one TRP in operation 615. In particular, in an example, UE 601 determines whether TRP #0 or TRP #1 is associated with the SSB index and/or the PRACH mask index.
   a) If UE 601 determines that TRP #0 is associated with the SSB index and/or the PRACH mask index, UE 601 may perform an RA procedure to TRP #O using the dedicated preamble. Once a maximum number of RA preamble transmission (e.g., preamble TransMax) is reached during the RA procedure to TRP #0, UE 601 may determine that the RA procedure to TRP #0 is failed and perform another RA procedure to TRP #1. For example, the dedicated preamble is not used during the abovementioned another RA procedure to TRP #1.
   b) If UE 601 determines that TRP #1 is associated with the SSB index and/or the PRACH mask index, UE 601 may perform an RA procedure to TRP #1 using the dedicated preamble. Once a maximum number of RA preamble transmission (e.g., preamble TransMax) is reached during the RA procedure to TRP #1, UE 601 may determine that the RA procedure to TRP #1 is failed and perform another RA procedure to TRP #0. For example, the dedicated preamble is not used during the abovementioned another RA procedure to TRP #0.
(2) In a further embodiment, if the SSB index and/or the PRACH mask index is indicated in the DCI, the dedicated preamble indicated in DCI can be used in all TRPs (e.g., both TRP #0 and TRP #1). UE 601 may perform an RA procedure to one TRP within all TRPs. For example, UE 601 may select a TRP (e.g., TRP #0) among the configured TRPs based on a channel quality and/or a bandwidth. For instance, once a maximum number of RA preamble transmission (e.g., preamble TransMax) is reached during an RA procedure to the selected TRP (e.g., TRP #0), UE 601 is allowed to perform another RA procedure to another TRP (e.g., TRP #1). The same preamble can be used in both RA procedures to the TRP (e.g., TRP #0) and the abovementioned another TRP (e.g., TRP #1).
(3) In another embodiment, if the SSB index and/or the PRACH mask index is not indicated in the DCI, UE 601 may select a TRP (e.g., TRP #1) among the configured TRPs based on a channel quality and/or a bandwidth. For instance, once a maximum number of RA preamble transmission (e.g., preamble TransMax) is reached during an RA procedure to the selected TRP (e.g., TRP #1), UE 601 is allowed to perform another RA procedure to another TRP (e.g., TRP #0).

FIG. 7 illustrates a flowchart of an exemplary procedure of wireless communications according to some embodiments of the present application. Details described in all other embodiments of the present disclosure are applicable for the embodiments shown in FIG. 7. Referring to FIG. 7, UE 701 may function as UE1 as shown in FIG. 1. In particular, exemplary procedure 700 includes following steps.

In operation 711, UE 701 accesses a serving cell of BS 702. In an embodiment, two or more TRPs configured by the serving cell are associated with different TA. A TAT timer may be configured for each TRP among the configured TRPs. For instance, a TRP (e.g., TRP #0) is associated with a TA. Another TRP (e.g., TRP #1) is associated with another TA which is different from the TA associated with TRP #0. Two different TAT timers are configured for TRP #0 and TRP #1, respectively.

In operation 712, all TAT timers (e.g., both TAT timers configured for TRP #0 and TRP #1) expire when UL data arrives.

In operation 713, UE 701 selects a TRP among the configured TRPs based on a channel quality and/or a bandwidth.

In operation 714, UE 701 performs an RA procedure to the selected TRP for UL synchronization. For instance, once a maximum number of RA preamble transmission (e.g., preamble TransMax) is reached during the RA procedure to the selected TRP (e.g., TRP #0), UE 701 is allowed to perform another RA procedure to another TRP (e.g., TRP #1).

FIG. 8 illustrates an exemplary flowchart of a PCell change procedure according to some embodiments of the present application. Details described in all other embodiments of the present disclosure are applicable for the embodiments shown in FIG. 8. Referring to FIG. 8, UE 801 may function as UE1 as shown in FIG. 1. In particular, exemplary procedure 800 includes following steps.

In operation 811, source BS 802 transmits an RRC reconfiguration message associated with a target cell, which includes measurement configuration(s), to UE 801, and UE 801 transmits a measurement report according to the measurement configuration(s). The target cell may be a PCell or a PSCell. In one embodiment, UE 801 reports capability information to source BS 802, e.g., whether UE 801 supports multiple TRPs with different TA or not.

In operation 812, source BS 802 decides to handover UE 801 based on the measurement report from UE 801.

In operation 813, source BS 802 transmits a handover request message to target BS 803.

In operation 814, target BS 803 performs an admission control based on the load and the service supported by target BS 803.

In operation 815, target BS 803 sends a handover request acknowledge message to source BS 802, which may include a transparent container to be sent to UE 801 as an RRC message to perform a handover procedure.

In an embodiment, only one TRP is allowed (e.g., as defined in 3GPP specification) to be configured to the target cell in the handover request acknowledge message from target BS 803. For example, only one TRP is allowed to be configured for a PCell change procedure (e.g., a normal handover), a PSCell addition procedure (e.g., a secondary cell group (SCG) addition), a PSCell change procedure (e.g., a SCG change), a CHO procedure, a CPA procedure, or a CPC procedure.

In a further embodiment, if multiple TRPs (e.g., two TRPs) having different TA are configured to the target cell in the handover request acknowledge message from target BS 803, target BS 803 may further configure to which TRP UE 801 can perform an RA procedure during mobility.
(1) In an example, in the handover request acknowledge message, target BS 803 may explicitly indicate whether UE 801 needs to perform an RA procedure to a concerned TRP when UE 801 receives the RRC reconfiguration message. For instance, if TRP #0 and TRP #1 are configured by target BS 803, target BS 803 may explicitly indicate UE 801 to perform an RA procedure to TRP #0 during mobility.
(2) In a further example, in the handover request acknowledge message, target BS 803 may explicitly indicate UE 801 not to perform an RA procedure to another TRP (e.g., TRP #1) during the RA procedure to a TRP (e.g., TRP #0), e.g., when T304 is running.
(3) In another example, in the handover request acknowledge message, target BS 803 may explicitly indicate UE 801 to perform the RA procedure to another TRP (e.g., TRP #1) after the RA procedure to a TRP (e.g., TRP #0), e.g., after an expiry of T304.
(4) In an additional example, in the handover request acknowledge message, target BS 803 may explicitly indicate UE 801 to perform the RA procedure to another TRP (e.g., TRP #1) after the RA procedure to a TRP (e.g., TRP #0) upon a DL data arrival.
(5) In yet an additional example, in the handover request acknowledge message, target BS 803 may explicitly indicate UE 801 to perform the RA procedure to another TRP (e.g., TRP #1) after the RA procedure to a TRP (e.g., TRP #0) upon a UL data arrival.

In some embodiments, in a case that target BS 803 indicates UE 801 not to perform an RA procedure to another TRP (e.g., TRP #1) immediately, UE 801 may perform the RA procedure to the abovementioned another TRP (e.g., TRP #1) for UL synchronization, e.g., when DL or UL data arrives. In some embodiments, in a case that target BS 803 indicates UE 801 to perform RA procedure(s) to both TRPs, UE 801 may perform the RA procedure(s) for the both TRPs immediately.

In operation 816, source BS 802 sends an RRC reconfiguration message to UE 801 after source BS 802 receives the handover request acknowledge message from target BS 803. Based on the RRC reconfiguration message, UE 801 may determine that only one TRP is allowed to be configured to the target cell by target BS 803, or UE 801 may determine to which TRP UE 801 can perform an RA procedure during mobility if two TRPs having different TA are configured to the target cell by target BS 803.

In operation 817, UE 801 starts a mobility timer (e.g., T304). In operation 818, UE 801 may perform an RA procedure to a TRP (e.g., TRP #0).
(1) In an embodiment, UE 801 stops T304 when UE 801 completes the RA procedure in TRP #0.
(2) In a further embodiment, UE 801 transmits an RRC reconfiguration complete message to target BS 803. The RRC reconfiguration complete message may be transmitted before, at the same time as, or after performing the RA procedure to the abovementioned another TRP (e.g., TRP #1).

In some embodiments, in operation 818, UE 801 may also perform an RA procedure to another TRP (e.g., TRP #1). For instance, UE 801 may perform the RA procedure to the abovementioned another TRP according to indication(s) from target BS 803. In an embodiment, based on the RRC reconfiguration message in operation 816, UE 801 may determine that target BS 803 indicates:
(1) not to perform the RA procedure to the abovementioned another TRP (e.g., TRP #1) during the RA procedure to the TRP (e.g., TRP #0), e.g., when T304 is running;
(2) to perform the RA procedure to the abovementioned another TRP (e.g., TRP #1) after the RA procedure to the TRP (e.g., TRP #0), e.g., after an expiry of T304; or
(3) to perform the RA procedure to the abovementioned another TRP (e.g., TRP #1) after the RA procedure to the TRP (e.g., TRP #0) upon a DL or UL data arrival.

It should be appreciated by persons skilled in the art that the sequence of the operations in any of exemplary procedures 500, 600, 700, and 800 may be changed and that some of the operations in any of exemplary procedures 500, 600, 700, and 800 may be eliminated or modified, without departing from the spirit and scope of the disclosure.

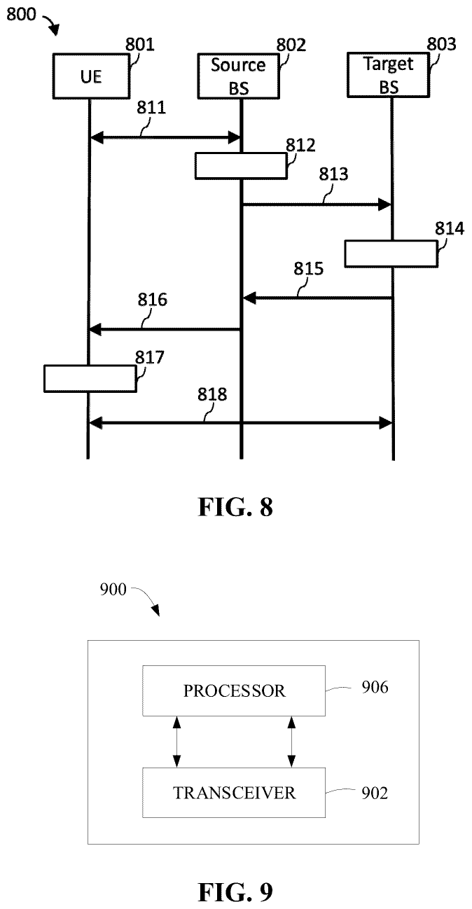

FIG. 9 illustrates a block diagram of an exemplary apparatus 900 according to some embodiments of the present application. As shown in FIG. 9, the apparatus 900 may include at least one processor 906 and at least one transceiver 902 coupled to the processor 906. The apparatus 900 may be a UE or a BS.

Although in this figure, elements such as the at least one transceiver 902 and processor 906 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE. The transceiver 902 and the processor 906 may interact with each other so as to perform the operations with respect to the UEs described above, for example, in FIGS. 1-8.

In some embodiments of the present application, the apparatus 900 may be a BS. The transceiver 902 and the processor 906 may interact with each other so as to perform the operations with respect to the BSs described above, for example, in FIGS. 1-8.

In some embodiments of the present application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to the UEs as described above. For example, the computer-executable instructions, when executed, cause the processor 906 interacting with transceiver 902 to perform the operations with respect to the UEs described in FIGS. 1-8.

For example, in some embodiments of the present disclosure, the non-transitory computer-readable medium may have stored thereon computer-executable instructions to cause the processor 906 to implement the method with respect to the BSs as described above. For example, the computer-executable instructions, when executed, cause the processor 906 interacting with transceiver 902 to perform the operations with respect to the BSs described in FIGS. 1-8.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with at the at least one memory and configured to cause the UE to:
access a serving cell with a first transmission reception point (TRP) associated with a first timing advance (TA);
receive a radio resource control (RRC) reconfiguration message related to a second TRP associated with a second TA from a network, wherein the second TA is different from the first TA; and
perform a first random access (RA) procedure to the second TRP after receiving the RRC reconfiguration message.

2. The UE of claim 1, wherein the first RA procedure is performed upon a reception of the RRC reconfiguration message.

3. The UE of claim 1, wherein the RRC reconfiguration message includes an indication for indicating whether the UE performs the first RA procedure upon a reception of the RRC reconfiguration message.

4. The UE of claim 3, wherein:
in response to the indication indicating the UE to perform the first RA procedure upon the reception of the RRC reconfiguration message, the first RA procedure is performed upon the reception of the RRC reconfiguration message; or
in response to the indication indicating the UE to not perform the first RA procedure upon the reception of the RRC reconfiguration message, the first RA procedure is performed upon a downlink (DL) data arrival or upon an uplink (UL) data arrival.

5. The UE of claim 2, wherein, in response to the first RA procedure failing, the at least one processor is further configured to cause the UE to transmit failure information related to the first RA procedure the network.

6. The UE of claim 2, wherein the at least one processor is further configured to cause the UE to transmit a RRC reconfiguration complete message to the network after successfully completing the first RA procedure or after failure of the first RA procedure.

7. The UE of claim 6, wherein the RRC reconfiguration complete message includes at least one of:
an indication of whether the first RA procedure is successfully completed; or information related to the first RA procedure.

8. The UE of claim 7, wherein the information includes at least one of:
one or more preamble sequences for one or more attempts during the first RA procedure; or one or more time-frequency domain resources for the one or more attempts.

9. The UE of claim 1, wherein the at least one processor is further configured to cause the UE to:
receive a first configuration regarding a first time alignment timer (TAT) for the first TA from the network; and
receive a second configuration regarding a second TAT for the second TA from the network.

10. The UE of claim 9, wherein, in response to both an expiry of the first TAT and an expiry of the second TAT and in response to a downlink (DL) data arrival, the at least one processor is further configured to receive downlink control information (DCI) including a physical downlink control channel (PDCCH) order from the network.

11. The UE of claim 10, wherein the PDCCH order includes a dedicated preamble, and wherein the dedicated preamble is used for both the first TRP and the second TRP or is used for only one TRP within the first TRP and the second TRP.

12. The UE of claim 11, wherein, in response to the DCI including at least one of a synchronization signal block (SSB) index or a physical random access channel (PRACH) mask index, the dedicated preamble is used for the only one TRP.

13. The UE of claim 12, wherein the at least one processor is further configured to cause the UE to:
determine whether the first TRP or the second TRP is associated with the at least one of the SSB index or the PRACH mask index; and
in response to determining that the first TRP is associated with the at least one of the SSB index or the PRACH mask index, perform a second RA procedure to the first TRP using the dedicated preamble; or
in response to determining that the second TRP is associated with the at least one of the SSB index or the PRACH mask index, perform a third RA procedure to the second TRP using the dedicated preamble.

14. The UE of claim 6, wherein the at least one processor is further configured to cause the UE to:
in response to reaching a first maximum number of preamble transmission of the second TRP, determine that the first RA procedure failed; or
in response to reaching a second maximum number of preamble transmission of the first TRP, determine that the second RA procedure failed; or
in response to reaching a third maximum number of preamble transmission of the second TRP, determine that the third RA procedure failed.

15. A network node for wireless communication, comprising:
at least one memory; and
at least one processor coupled with the at least one memory and configured to cause the network node to:
transmit a first radio resource control (RRC) reconfiguration message related to a first transmission reception point (TRP) associated with a first timing advance (TA) to a user equipment (UE);
receive a measurement report of the first TRP from the UE; and
transmit a second RRC reconfiguration message related to a second TRP associated with a second TA to the UE, wherein the second TA is different from the first TA.

16. A user equipment (UE) for wireless communication, comprising:
at least one memory; and
at least one processor coupled with the at least one memory and configured to cause the UE to:
receive a radio resource control (RRC) reconfiguration message associated with a target cell from a network,
wherein the RRC reconfiguration message includes a configuration related to one or more transmission reception points (TRPs) of the target cell, and wherein two or more TRPs within the one or more TRPs have a different timing advance (TA) in response to the configuration being related to the two or more TRPs; and
perform a first random access (RA) procedure and start a mobility timer.

17. The UE of claim 16, wherein the target cell is a primary cell of a master cell group (PCell) or a primary cell of a second cell group (PSCell).

18. The UE of claim 16, wherein in response to allowing only one TRP to be configured to the target cell, the configuration is related to the one TRP, and the first RA procedure is related to the one TRP.

19. The UE of claim 18, wherein the first RA procedure is associated with at least one of:
a PCell change procedure;
a PSCell addition procedure;
a PSCell change procedure;
a conditional PCell handover (CHO) procedure;
a conditional PSCell addition (CPA) procedure; or
a conditional PSCell change (CPC) procedure.

20. The UE of claim 16, wherein in response to the configuration being related to the two or more TRPs, the RRC reconfiguration message includes information regarding each TRP within the two or more TRPs.
